(19) United States
(12) Patent Application Publication
(10) Pub. No.: US 2015/0205765 A1
(43) Pub. Date: Jul. 23, 2015

(54) FONT PROCESS METHOD AND FONT PROCESS SYSTEM

(71) Applicant: ARPHIC TECHNOLOGY CO., LTD., New Taipei City (TW)

(72) Inventors: Fu-Sheng Wu, New Taipei City (TW); Wan-Chih Chen, New Taipei City (TW); Hui-Yen Tsai, New Taipei City (TW)

(21) Appl. No.: 14/304,978

(22) Filed: Jun. 15, 2014

(30) Foreign Application Priority Data
Jan. 20, 2014 (TW) 103102025

(51) Int. Cl. G06F 17/21; G06F 17/24

(52) U.S. Cl. CPC G06F 17/214; G06F 17/24

(57) ABSTRACT

When opening a document, the character codes of all characters in the document are uploaded to a font server, then all possible glyphs corresponding to the uploaded character codes of characters tagged with a font are selected from a font file which stores a plurality of glyphs of the font to form a glyph subset. And the glyph subset is then downloaded.

### BACKGROUND OF THE INVENTION

1. Field of the Invention

The present invention relates to a font process method, and more particularly, a font process method used to form a glyph subset corresponding to characters in a document of a user device.

2. Description of the Prior Art

According to a prior art, when a user opens a document on a user device connecting to an internet via a wired or wireless network, if a required font file related to a character of the document is not installed in the user device, the document is not displayed correctly on the user device. In this case, the required font file can be downloaded via the internet so that the document can be normally opened and displayed with glyphs stored in the font file. However, a glyph part of a font file occupies the majority of the file size of the font file because each glyph is a graphical pattern file. Hence, it is helpful to only download the required glyphs for displaying a document instead of downloading the complete glyph part of a font file which contains all glyphs and has huge file size up to tens of megabytes. By only downloading the required glyphs, download time is accordingly reduced, and also the document can be opened more quickly. The abovementioned “character” means a character belonging to a language and corresponding to a Unicode code or an ASCII code, and the definition of “character” is kept hereinafter. For example, a Latin alphabetic “A” corresponds to Unicode code 0x0041 so that “A” is considered as an character. For another example, a Hindi glyph “ [symbol] ” is not corresponding to any Unicode code or ASCII code so that “ [symbol] ” is not considered as a Hindi character.

In order to only download the required glyphs for displaying a document correctly and also assure that the downloaded glyphs are enough, the following method is taken according to prior art. When a user device opens a document and it is detected that a required font file is not installed in the user device, the user device sends the document to a font server via an internet for a layout engine in the font server to perform a real-time analysis on a plurality of characters and combinations of the characters according to a context of the document so that at least one glyph required for correctly displaying the document is obtained after the analysis, and a font subset including the required glyphs is then sent to the user device from the font server. The format of the mentioned font subset is identical to the format of the font file except for the glyph part. The font subset does not include all glyphs but only includes the glyphs required for displaying the document. After the user device receives the font subset, a layout engine stored in the user device (e.g. a layout engine in a browser installed in a smartphone) analyzes and combines the characters in the document by referring to the context of the document according to glyph-combination rules of a complex language (e.g. Hindi, Thai or Myanmar) so as to display the document correctly.

Although the above mentioned method of prior art has reduced download time and file size of the downloaded file by avoiding downloading a complete font file with huge file size, the time spent on real-time analysis still long enough to delay the opening of the document and make a user wait. Moreover, for learning the glyphs required for displaying the document, the layout engine of the font server analyzes the document first, and then another layout engine installed in the user device needs to analyze the characters and the relationship of the characters in the context of the document so as to arrange the downloaded glyphs. If the layout engine of the font server and the layout engine of the user device adopt different algorithms or analyzers, it is possible to lead to incorrect display.

Especially when opening a document in a complex language (e.g. Hindi, Thai, Arabic or Myanmar), the mentioned shortages happen with higher probability. Therefore, a font process method is required to reduce time for downloading required glyphs and also enhance the correctness of the displaying of the document, particularly for documents including characters of one or more complex languages such as Hindi, Thai, Arabic, Bengali and/or Myanmar.

### SUMMARY OF THE INVENTION

An embodiment of the present invention discloses a font process method. The method comprises storing a font file in a font server, the font file having a plurality of glyphs of a font; analyzing a feature table of the font file so as to collate a code corresponding to each character of the font file, and at least a glyph index of glyphs corresponding to an original form, variation forms, and/or ligatures of the character to form a lookup table; sending codes of all characters in a document from a user device to the font server; looking up the codes of all the characters in the document by the font server according to the lookup table so as to capture an inquiry set of glyphs corresponding to the codes of all the characters of the font in the document and an output set of glyphs corresponding to combinations of the codes of all the characters of the font in the document from the font file to form a glyph subset; and sending the glyph subset from the font server to the user device.

Another embodiment of the present invention discloses a font process method. The method comprises storing a font file in a font server, the font file having a plurality of glyphs of a font; analyzing a feature table of the font file so as to collate a code corresponding to each character of the font file, and at least a glyph index of glyphs corresponding to an original form, variation forms, and/or ligatures of the character to form a lookup table; sending codes of all characters in a document from a user device to the font server; looking up the codes of all the characters in the document by the font server according to the lookup table so as to capture an inquiry set of glyphs corresponding to the codes of all the characters of the font in the document and an output set of glyphs corresponding to combinations of the codes of all the characters of the font in the document from the font file to form a glyph subset; combining the glyph subset and a remaining portion other than the plurality of glyphs in the font file to form a font subset; and sending the font subset from the font server to the user device.

Another embodiment of the present invention discloses a font process system. The system comprises a user device and a font server. The user device has a document. The font server has a font file and a lookup table. The font file stores a plurality of glyphs of a font. The font file has a feature table. The lookup table is formed by analyzing the feature table so as to collate a code corresponding to each character of the font file, and at least a glyph index of glyphs corresponding to an original form, variation forms, and/or ligatures of the characters. The user device sends codes of all characters in the document from the user device to the font server. The font server looks up the codes of all the characters in the document according to the lookup table so as to capture an inquiry set of glyphs corresponding to the codes of all the characters of the font in the document and an output set of glyphs corresponding to combinations of the codes of all the characters of the font in the document from the font file to form a glyph subset. The font server combines the glyph subset and a remaining portion other than the plurality of glyphs in the font file to form a font subset. The font server sends the font subset to the user device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a font file according to an embodiment of the present invention.

FIG. 2 illustrates the character code to glyph index mapping table (CMAP) of FIG. 1 according to an embodiment of the present invention.

FIG. 3 illustrates the glyph part of FIG. 1 according to an embodiment of the present invention.

FIG. 4 illustrates the feature table of FIG. 1 according to an embodiment of the present invention.

FIG. 5 illustrates a lookup table according to an embodiment of the present invention.

FIG. 6 illustrates a block diagram of a font process system to form a font subset with a font process method according to an embodiment of the present invention.

FIG. 7 illustrates a flow chart of a font process method according to an embodiment of the present invention.

### DETAILED DESCRIPTION

When a user opens a document on a user device connecting to internet, such as a smartphone, a desktop computer, an industrial computer, a television set, a wearable device (e.g. a smart glasses or smart watch), a smart household device (e.g. an internet refrigerator) or a car electronic device, each character in the document needs to be displayed with correct glyphs so as to display the document correctly on the user device.

For example, when some parts of a document are written in Hindi language, a Hindi character “ [symbol] ” (Unicode code: 0x0928) needs to be displayed as “ [symbol] ”, “ [symbol] ” or “ [symbol] ” by following some glyph-combination rules or glyph-variation rules of Hindi. In this example, each of “ [symbol] ”, “ [symbol] ”, “ [symbol] ” or “ [symbol] ” displayed on the user device corresponds to a same Hindi character “ [symbol] ” (Unicode code: 0x0928). However, in different conditions, the displayed graphical patterns (e.g. “ [symbol] ”, “ [symbol] ”, “ [symbol] ” and “ [symbol] ”) are different, and each different displayed pattern is displayed with a “glyph”. In this case, glyph “ [symbol] ” is an original form of the character “ [symbol] ”, and glyphs “ [symbol] ”, “ [symbol] ” and “ [symbol] ” are three different “variation forms” of character “ [symbol] ”. Hence, a character is “ [symbol] ” is corresponding to four glyphs: “ [symbol] ”, “ [symbol] ”, “ [symbol] ” and “ [symbol] ”.

For another example, when a document includes characters “A” (Unicode code: 0x0041) and “E” (Unicode code: 0x0045), a layout engine may determine to combine the two characters A and E to form a ligature “ [symbol] ” (Unicode code: 0x00C6) by following a linguistic rule (e.g. a Danish linguistic rule). In this case, each of the character “A”, the character “E” and the ligature “ [symbol] ” is corresponding to a glyph to record its displayed graphical pattern. For yet another example, a characters “O” (Unicode code: 0x004F) and a character “E” (Unicode code: 0x0045) can also be combined to form another ligature “ [symbol] ” (Unicode code: 0x0152).

From the above examples, it is known that when a document includes a character, according to linguistic rules of a language corresponding to the character, the following items may need to be displayed corresponding to the character:
(a) an original form of the character, for example, the original form “A” of a character “A”;
(b) at least one variation form of the character, for example, variation forms “Ā”, “\check{A}”, “ [symbol] ”, “Å” and/or “Ã” of a character “A”; and/or
(c) at least one ligature combined with the character and at least one another character, for example, a ligature “ [symbol] ” combined with the character “A” and another character “E”; and for another example, a ligature “ [symbol] ” combined with the character “0” and another character “E”.

Each of the abovementioned original forms (such as “A” relative to A), at least a variation form (such as Ā, \check{A}, [symbol] , Å and Ã relative to A) and at least a ligature (such as [symbol] and [symbol] relative to combinations of “E” and some other character) is corresponding to a glyph which is a graphical pattern recorded for displaying. When displaying an original form, a variation form or a ligature of a character tagged with a font on a user device, it is necessary to capture a corresponding glyph from at least one glyph stored in a font file belonging to the font and then display with the captured glyph on the user device.

In the foregoing examples, the mentioned ligature (e.g. [symbol] and [symbol] corresponding to a character E) is also a character corresponding to a Unicode code. For example, the ligature [symbol] corresponds to a Unicode code 0x00C6, and the ligature [symbol] corresponds to a Unicode code 0x0152. The mentioned ligature corresponding to a Unicode code (e.g. [symbol] or [symbol] ) is also considered as a character. However, when processing a document composed in a complex language (e.g. Hindi, Arabic or Thai), if a plurality of characters need to be combined as a longer ligature (which is usually a word) according to linguistic rules, it is necessary to capture glyphs of original form and/or glyphs of variation form of the plurality of characters for a layout engine to combine the captured glyphs by following linguistic rules of the language so as to display the longer ligature. For example, when displaying an Hindi word which is composed with the following six Hindi characters: [symbol] , [symbol] , [symbol] , [symbol] , [symbol] and [symbol] (Unicode code: 0x0939, 0x093F, 0x0928, 0x094D, 0x0926 and 0x0940) in an Hindi document, the six characters should be displayed as a combination instead of being displayed separately, and the combination of the six characters is “ [symbol] ” (which means “Hindi language” in Hindi). In this example, character [symbol] (Unicode code: 0x0939) corresponds to 1 glyph: [symbol] ; character [symbol] (Unicode code: 0x093F) corresponds to 8 glyphs: [symbol] , [symbol] , [symbol] , [symbol] , [symbol] , [symbol] , [symbol] and [symbol] ; character [symbol] (Unicode code: 0x0928) corresponds to 4 glyphs: [symbol] , [symbol] , [symbol] and [symbol] ; character [symbol] (Unicode code: 0x094D) corresponds to 1 glyph: [symbol] ; character [symbol] (Unicode code: 0x0926) corresponds to 2 glyphs: [symbol] and [symbol] ; and character [symbol] (Unicode code: 0x0940) corresponds to 7 glyphs: [symbol] , [symbol] , [symbol] , [symbol] , [symbol] , [symbol] and [symbol] .

Hence, the six characters correspond to 23 (=1+8+4+1+2+7) glyphs in total. After analyzing with Hindi linguistic rules, the six characters are further combined and displayed as “ [symbol] ”. In this case, in the 23 glyphs of the original forms and the variation forms corresponding to the six characters, only 5 glyphs ( [symbol] , [symbol] , [symbol] , [symbol] and [symbol] ) are chosen and used. The above example is to describe how to perform a layout process and character combination in a complex language such as Hindi.

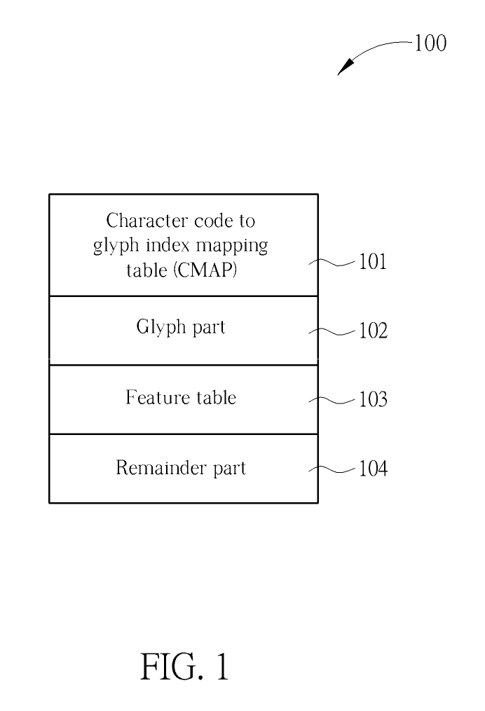

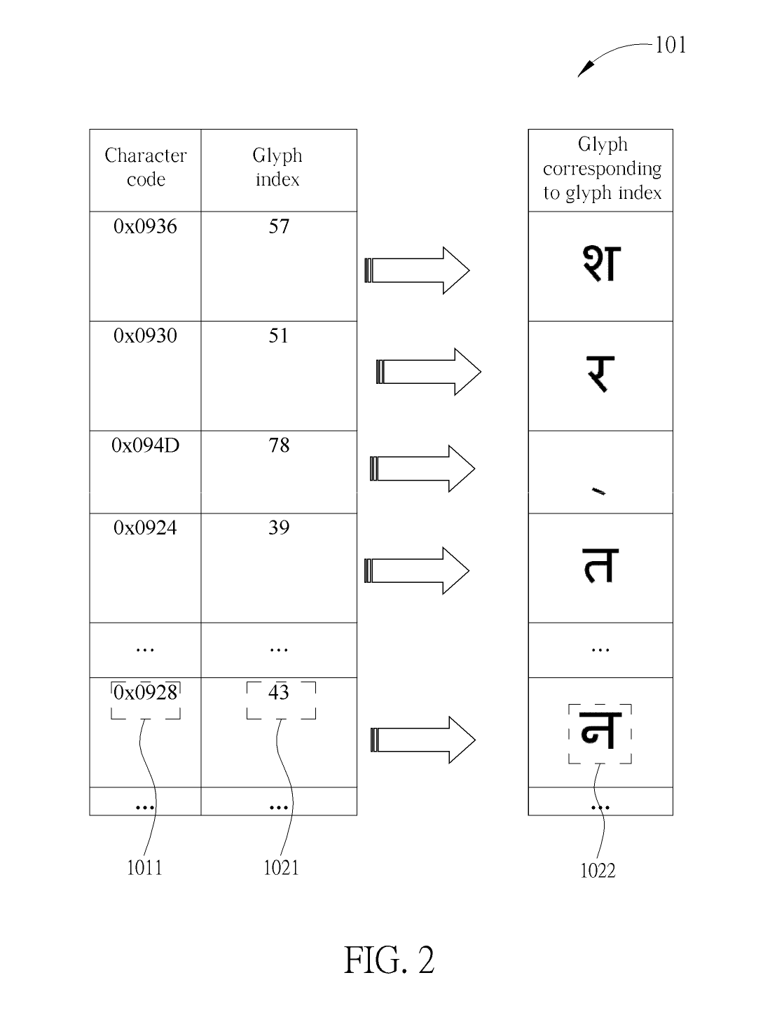

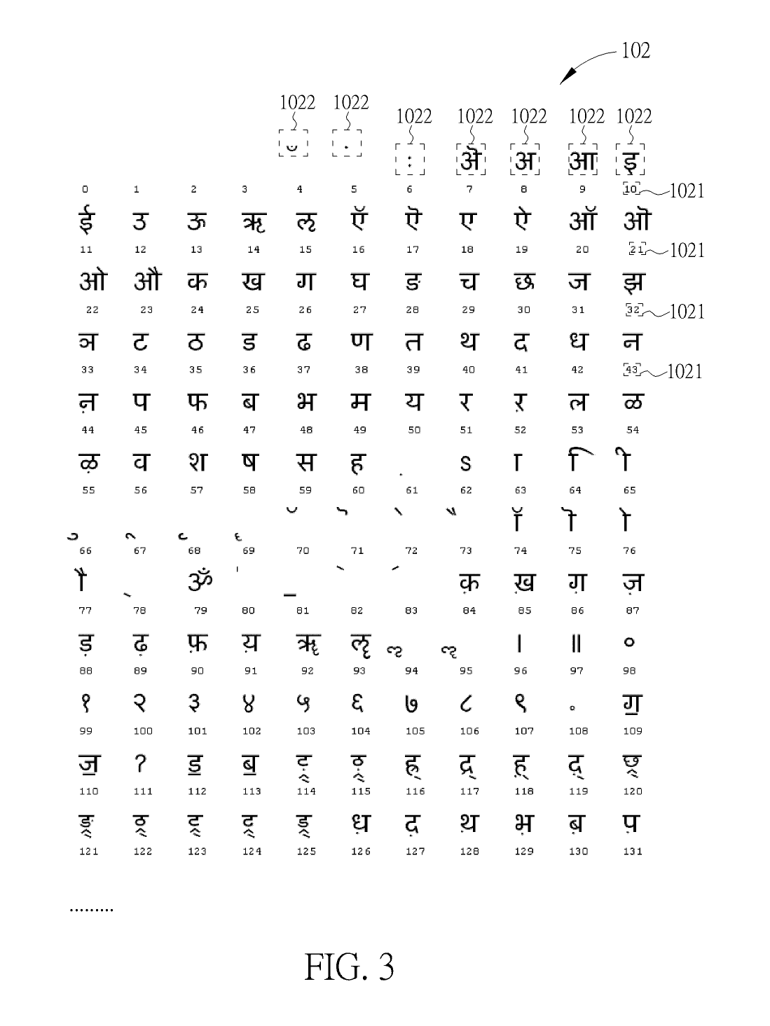

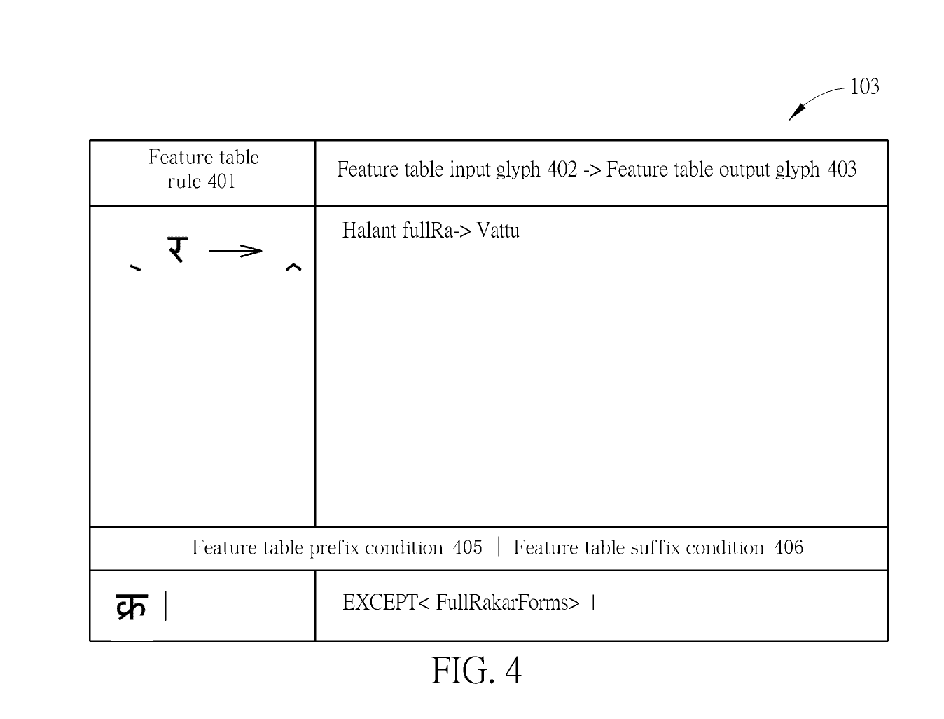

Please refer to FIG. 1 to FIG. 4. FIG. 1 illustrates a font file 100 according to an embodiment of the present invention. FIG. 2 illustrates the character code to glyph index mapping table (CMAP) 101 of the font file 100 of FIG. 1 according to an embodiment of the present invention. FIG. 3 illustrates the glyph part 102 of the font file 100 according to an embodiment of the present invention. FIG. 4 illustrates the feature table 103 of the font file 100 of FIG. 1 according to an embodiment of the present invention. FIG. 1 to FIG. 4 are only used as illustrations but not to limit the scope of the present invention or to represent real computer programs. In addition to the CMAP 101, the glyph part 102, the feature table 103, the font file 100 also includes a remainder part 104.

Please refer to FIG. 2. The character code to glyph index mapping table (CMAP) 101 in FIG. 2 is a mapping table recording relationships between each character code 1011 (which may be an Unicode code or an ASCII code) and a corresponding glyph index 1021. Each glyph index 1021 corresponds to a single glyph 1022 which is a graphic pattern, and each glyph 1022 is with a glyph index 1021 as its serial number. Please refer to FIG. 2. For example, the character code 1011 of the Hindi character “ [symbol] ” is an Unicode code 0x0936, and it corresponds to a glyph index 1021 which is assigned as number 57 (as shown in the first row of CMAP 101 of FIG. 2). For another example, the character code 1011 of another Hindi character “ [symbol] ” is an Unicode code 0x0928, and it corresponds to a glyph index 1021 which is assigned as number 43 (as shown in the last row of CMAP 101 of FIG. 2). In the CMAP 101, only the glyphs 1022 corresponding to character codes 1011 are recorded. In other words, in a complete font file 100, there are other glyphs 1022 which are with corresponding glyph indexes 1021 but without corresponding character codes 1011, and those glyphs 1022 without corresponding character codes 1011 are not recorded in the CMAP 101. For example, the mentioned Hindi character “ [symbol] ” is a glyph with a character code (which is a Unicode code: 0x0928) so that the glyph “ [symbol] ” is allowed to be recorded in the CMAP 101. However, a glyph “ [symbol] ”, another glyph “ [symbol] ” and yet another glyph “ [symbol] ”, three variation forms of the Hindi character “ [symbol] ”, are not recorded in the CMAP 101 because each of the three glyphs does not correspond to any character code such as a Unicode code.

Please refer to FIG. 3. FIG. 3 illustrates the glyph part 102 of the font file 100 of FIG. 1 according to an embodiment of the present invention. The glyph part 102 records all glyphs 1022 and the corresponding glyph indexes 1021. FIG. 3 is only an illustration but not a complete glyph part because the number of the glyphs 1022 is too large, for example, more than 1000 glyphs are used in the Hindi language. Because each glyph 1022 is a graphical pattern, the glyph part 102 occupies the most storage space of the font file 100. No matter whether a glyph 1022 corresponds to a character code 1011 (such as an Unicode code) or not, each glyph 1022 corresponds to a glyph index 1021 and is recorded in the glyph part 102.

Please refer to FIG. 4. FIG. 4 illustrates a feature table 103 of the font file 100 according to an embodiment of the present invention. The feature table 103 records combination rules and variation rules of a corresponding language. The combination rules and variation rules describe how a glyph (of an original form, at least a variation form and/or at least a ligature of a character) is combined with other glyphs or converted to another glyph. Regarding the definitions of “original form”, “variation form” and “ligature”, please refer to the above description. FIG. 4 only shows a part of the feature table 103. The number of the feature table rules 401 is too large to be shown in FIG. 4, hence only one feature table rule 401 is shown as an example. According to an embodiment, the feature table 103 of FIG. 4 describes that when a glyph “ [symbol] ” (which is the Hindi character “Halant” corresponding to a glyph index 78 and having a character code that is Unicode code 0x094d) is arranged in a first position, a glyph “ [symbol] ” (which is the Hindi character “fullRa” corresponding to a glyph index 51 and having a character code that is Unicode code 0x0930) is arranged in a following second position, and there does not exist any glyph belonging to a group “FullRakar” before the glyph “ [symbol] ” and the glyph “ [symbol] ”, the glyph “ [symbol] ” and the glyph “ [symbol] ” can be combined as a set of feature table output glyph 403 that is a glyph “ [symbol] ” (which is the Hindi character “Vattu” corresponding to a glyph index 155 but NOT corresponding to a character code). In the feature table 103 of FIG. 4, the condition relative to that glyph of the group “FullRakar” is not arranged before the glyphs “ [symbol] ” and “ [symbol] ” is recorded as a feature table prefix condition 405 which is represented with “EXCEPT <FullRakarForms>|” in FIG. 4. The glyph “ [symbol] ” in the lower left blank represents all glyphs of the group “FullRakar” because the glyph “ [symbol] ” is the first glyph of the group “FullRakar”. The above description takes the feature table prefix condition 405 as an example to explain a condition about that some specific glyphs do not exist in a beginning position when combining multiple glyphs. As for a condition about that some specific glyphs do not exist in a following position when combining multiple glyphs, it can be set as a feature table suffix condition 406. From the feature table 103 of FIG. 4, it is introduced that how combination rules between different glyphs and variation rules of a signal glyph are recorded in the feature table 103.

As noted above, the glyph part 102 stores all graphical patterns for displaying, so the glyph part 102 occupies the most storage space in the font file 100 of FIG. 1. Hence, downloading one or more glyphs required for displaying a document instead of downloading the complete glyph part is helpful to reduce download time greatly so as to speed up the opening of the document. However, it requires longer analysis time to capture the required one or more glyphs for display the document correctly, hence a solution for reducing the analysis time without downloading a complete glyph part is required in the field.

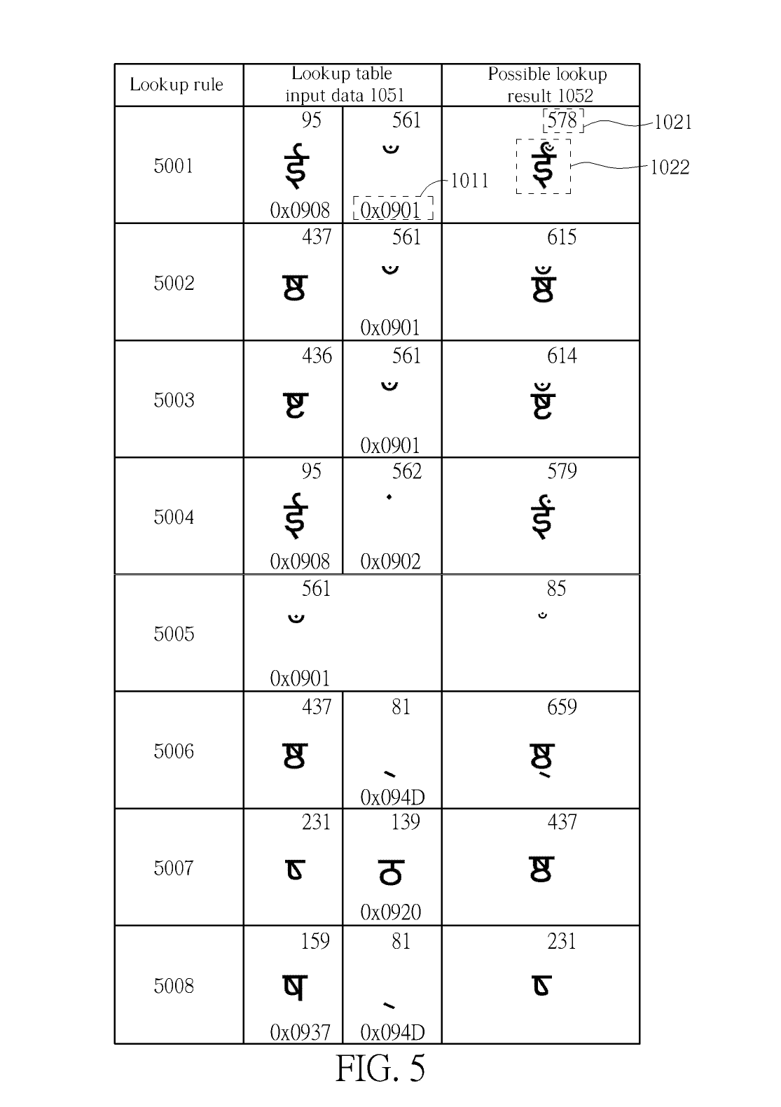

Please refer to FIG. 5. FIG. 5 illustrates a lookup table 105 according to an embodiment of the present invention. The lookup table 105 is obtained by analyzing the CMAP 101, the glyph part 102 and the feature table 103 of the font file 100. The relationships between character codes and corresponding glyph indexes of glyphs of original forms, variation forms and ligatures are considered and recorded in the lookup table 105. According to an embodiment of the present invention, the lookup table 105 is stored in a font server. When a document is opened on a user device, it is not necessary to perform a real-time analysis for one or more characters in the document with consideration of the dependency between the characters in the context. That means that the lookup table 105 does not include conditions relative to the context-relationships and the arrangement of the characters such as the feature table prefix condition 405 or the feature table suffix condition 406 shown in the feature table 103. When using the lookup table 105, the sequence of position of each character existing in a document is not concerned, either. After sending character codes 1011 of all characters existing in a document to the font server, the required one or more glyphs 1022 for displaying the document correctly are obtained after performing one or more times of lookup process with the lookup table 105. With the lookup table 105, it is unnecessary to consider the combination rule or variation rule of a complex language. The lookup table 105 just records that the possibly generated glyphs (such as those glyphs shown in possible lookup result 1052) corresponding to one or more characters and/or glyphs existing in a document (such as those sets of glyphs shown in the lookup table input data 1051). For example, after a document is opened, the steps of the lookup process are described below if the following character codes 1011 (in Unicode code format) of Hindi characters are found in the document: 0x0937, 0x094d, 0x0920 and 0x0901 (which are corresponding to Hindi glyphs [symbol] , [symbol] , [symbol] and [symbol] ). Please also refer to the lookup table 105 shown in FIG. 5.

The first round of lookup:

Because Unicode 0x0901 (corresponding to glyph [symbol] with a glyph index 561) meets a lookup rule 5005, a glyph [symbol] with glyph index 85 is obtained. Likewise, because the set of Unicode 0x0937 and 0x094d (corresponding to glyphs [symbol] and [symbol] with glyph indexes 159 and 81) meets another lookup rule 5008, a glyph [symbol] with a glyph index 231 is obtained. So far, glyphs corresponding to glyph indexes 159, 81, 139, 561, 85 and 231 are obtained according to the lookup table 105.

The second round of lookup:

Because the glyph [symbol] (corresponding to a glyph index 231) obtained in the first round of lookup along with the glyph [symbol] (corresponding to a glyph index 139 and a Unicode code 0x0920) meet a lookup rule 5007 shown in the lookup table 105, a glyph [symbol] corresponding to a glyph index 437 is obtained. So far, glyphs corresponding to glyph indexes 159, 81, 139, 561, 85, 231 and 437 are obtained according to the lookup table 105.

The third round of lookup:

Because the glyph [symbol] corresponding to the glyph index 437 is obtained in the second round of lookup, the glyph [symbol] along with a glyph [symbol] (corresponding to the glyph index 561) meet a lookup rule 5002 so that a glyph [symbol] corresponding to a glyph index 615 is obtained. Likewise, because the glyph [symbol] along with the glyph [symbol] (corresponding to the glyph index 561 and Unicode code 0x094d) meet a lookup rule 5006, a glyph [symbol] corresponding to a glyph index 659 is obtained. So far, the glyphs corresponding to glyph indexes 561, 159, 81, 85, 139, 231, 437, 615 and 659 are obtained.

The fourth round of lookup:

No new result is obtained according to the lookup table 105 shown in FIG. 5, so the lookup process finishes.

According to the above example, when an Hindi document includes four characters corresponding to Unicode codes 0x0937, 0x094d, 0x0920 and 0x0901, the glyphs [symbol] , [symbol] , [symbol] , [symbol] , [symbol] , [symbol] , [symbol] , [symbol] and [symbol] corresponding to the glyph indexes 561, 159, 81, 85, 139, 231, 437, 615 and 659 are obtained after the lookup process finally. The obtained glyphs are downloaded by a user device (such as a smartphone or a laptop computer) for a layout engine installed in the user device to use for analyzing and displaying the document.

The lookup table 105 illustrated in FIG. 5 is a small lookup table with only 8 lookup rules (which are the lookup rules 5001-5008), and is only used to demonstrate how to perform a lookup process by referring to a lookup table according to an embodiment of the present invention. In practical case, a much larger lookup table with more lookup rules is adopted. Compared with prior art, the lookup table 105 is installed in a font server according to the method disclosed by the present invention. Hence, character codes of all characters of a document are uploaded to the font server directly after the document is opened, then the lookup process described above is performed round by round repeatedly, all obtained output glyphs in a round of lookup are added into the input data for the next round of lookup, the lookup process is performed repeatedly until no new output glyph is obtained in a round of lookup according to the lookup table, and the lookup process finishes. After the lookup process finishes, the set of glyph (including one or more glyphs) obtained from the lookup process, known as a “glyph subset”, is a subset of a complete set of glyphs in the font file stored in the font server. The glyph subset includes necessary glyphs for displaying the document correctly. In other words, according an embodiment of the present invention, a font server performs a lookup process by looking up a glyph subset in a lookup table, then adding one or more obtained glyphs into the glyph subset to update the glyph subset, and then looking up the updated glyph subset again. After the lookup process, the finally obtained glyph subset is sent to the user device for the layout engine installed in the user device to combine glyphs or convert glyphs for displaying the document.

According to prior art, a font server needs to operate a layout engine to analyze a plurality of characters existing in a document with considering the context-relationship by following linguistic rules (such as Hindi linguistic rules) so as to obtain required glyphs (including original forms, variation forms and/or ligatures) for displaying the document. The analysis made by the layout engine is more accurate, so the number of obtained glyphs according to prior art is smaller, but the analysis time in the prior art is longer. Besides, after sending the obtained glyphs to a user device, for displaying the characters in the document correctly, another layout engine installed in the user device (such as a layout engine built in a browser in a smart phone) needs to analyze the characters in the document again to determine the use of glyphs of original forms, variation forms and/or ligatures, and this leads to incorrect displaying (such as unreadable gibberish or incorrect blank square) if the versions or adopted algorithms of the two layout engines in the user device and the font server are not consistent with one another. However, the disclosed lookup table 105 according to the present invention is generated by analyzing the CMAP 101, the glyph part 102 and the feature table 103 by means of a software analyzer with considering linguistic rules of a complex language, and the generated lookup table 105 can be reviewed by linguists professionals in a complex language before the lookup table is issued. Briefly, adopting the lookup table 105 disclosed by the present invention is equivalent to analyzing the linguistic rules of a complex language in advance, hence a dynamic analysis on characters for analyzing the context and the linguistic rules is no longer necessary. It is only required to look up the one or more glyphs and/or characters existing in a document in the lookup table so as to obtain the corresponding glyphs which are possibly needed for displaying the document. (Each character corresponds to a character code and at least one glyph, but some glyphs do not correspond to any character code.) Therefore, the number of the obtained output glyphs after performing the abovementioned lookup process with the lookup table 105 is larger than prior art, but the analysis time is reduced, and the wrong display caused by inconsistence between layout engines in the font server and the user device can also be prevented.

According to another embodiment of the present invention, and taking the abovementioned six Hindi characters [symbol] , [symbol] , [symbol] , [symbol] , [symbol] and [symbol] which are combined as a Hindi word [symbol] (which means “Hindi language” in Hindi) for example, when a user opens a document including the six Hindi characters [symbol] , [symbol] , [symbol] , [symbol] , [symbol] and [symbol] belonging to a same font (such as font “Ar Hebe Sans Hi Regular” of Hindi), a set of character codes of the six characters [symbol] , [symbol] , [symbol] , [symbol] , [symbol] , and [symbol] , that is Unicode codes 0x0939, 0x093F, 0x0928, 0x094D, 0x0926 and 0x0940, are sent to a font server. The font server looks up the set of character codes in a lookup table generated by an analysis in advance so as to obtain these 23 glyphs required for displaying the document when the six characters exist in the same document concurrently: [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] and [symbol] (which can correspond to glyph indexes 0939, 1019-1026, 43, 1005-1007, 094D, 0999-1000, 1029-1035, for example). It is not needed to analyze the context of the document to performing the lookup process, but only needed to upload all character codes existing in the document to the font server. The 23 glyphs are captured from the glyph part 102 of the font file 100 to be a “glyph subset”, and a remaining portion other than the glyph part 102 (which includes the CMAP 101, the feature table 103 and the remainder part 104 shown in FIG. 1) is integrated with the glyph subset to form a “font subset” to be downloaded by the user device from the font server. Then, a layout engine in the user device analyzes the six characters existing in the document so as to determine how to use glyphs of the variation forms or how to combine the glyphs with considering the context of the document, and then uses the 23 glyphs for all possible displaying results to display the document correctly based on the analysis. If the method disclosed by the present invention is not used, the font server needs to consider the Hindi linguistic rules to perform a dynamic dependency analysis for the six characters with consideration of the context of the document, and then it will be learned that only five glyphs are required for combining the six Hindi characters after the dynamic analysis, so a smaller font subset with only 5 glyphs is downloaded by the user device. However, there are around 1000 glyphs in a complex language such as Hindi, so the difference of downloading 23 glyphs to downloading 5 glyphs is less than 2% (which is calculated with the equation: 23/1000 −5/1000=0.018=1.8% <2%), and the difference of download loading is even smaller after considering that the remaining portion other than the glyph part is also downloaded when downloading the font subset. Therefore, using the method disclosed by the present invention may increase the download loading in a very small ratio, but the analysis time can be reduced greatly without performing dynamic real-time analysis on the context of the document, and the incorrect display caused by inconsistence between the font server and the user device is also prevented.

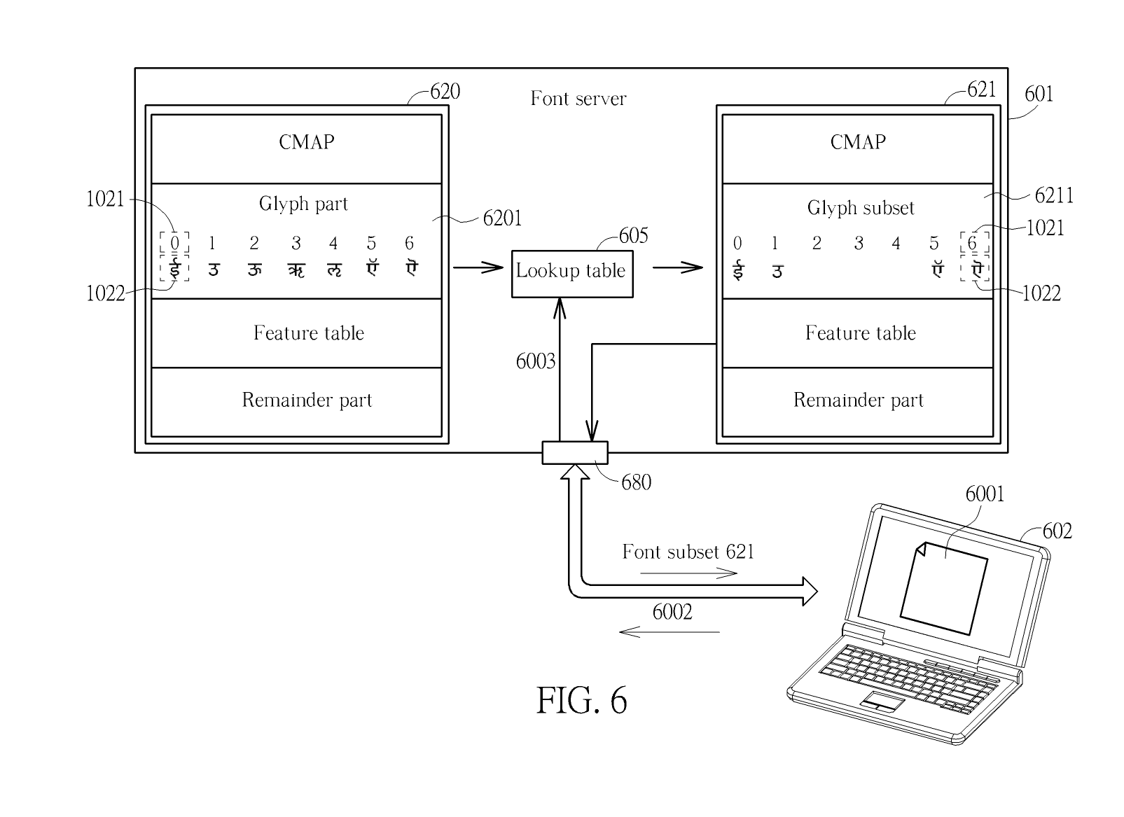

Please refer to FIG. 6. FIG. 6 illustrates a block diagram of a font process system to form a font subset with a font process method according to an embodiment of the present invention. It is only used to explain the present invention but not to limit the scope of the present invention or to represent a real system structure or real programming code. FIG. 6 shows a user device 602, a document 6001, one or more character codes of document 6002, a font server 601, a font file 620, a lookup table 605 and a font subset 621. According to FIG. 6, when a user opens the document 6001, if the character codes of document 6002 existing in the document 6001 belongs to a font corresponding to the font file 620, and the font file 620 is not installed in the user device 602, the character codes of document 6002 of the document 6001 is uploaded to the font server to 601 so that a set of glyphs corresponding to the character codes of document 6002 are captured from a complete glyph part 6201 of the font file 620 with a larger file size after a lookup process and integrated as a glyph subset 6211, the glyph subset 6211 is then combined with a remaining portion other than the glyph part 6201 in the font file 620 so as to form a font subset 621, and the font subset 621 is downloaded by the user device 602 to display the document 6001 by using the font subset 621. According to an embodiment shown in FIG. 6, before the user device 602 uploads the character codes of document 6002, the context-relationships between the characters of the document 6001 are not analyzed according to linguistic rules. After comparing the glyph part 6201 with the glyph subset 6211 according to the embodiment shown in FIG. 6, it is known that in the glyph subset 6211, the glyph indexes corresponding to the glyphs which are not chosen into the glyph subset 6211 are still kept in the glyph subset 6211 (such as the glyph indexes 2, 3 and 4 shown in the glyph subset 6211) but the corresponding storage spaces are empty without storing glyphs (which are graphical patterns), so the file size can be reduced when downloading the font subset 621.

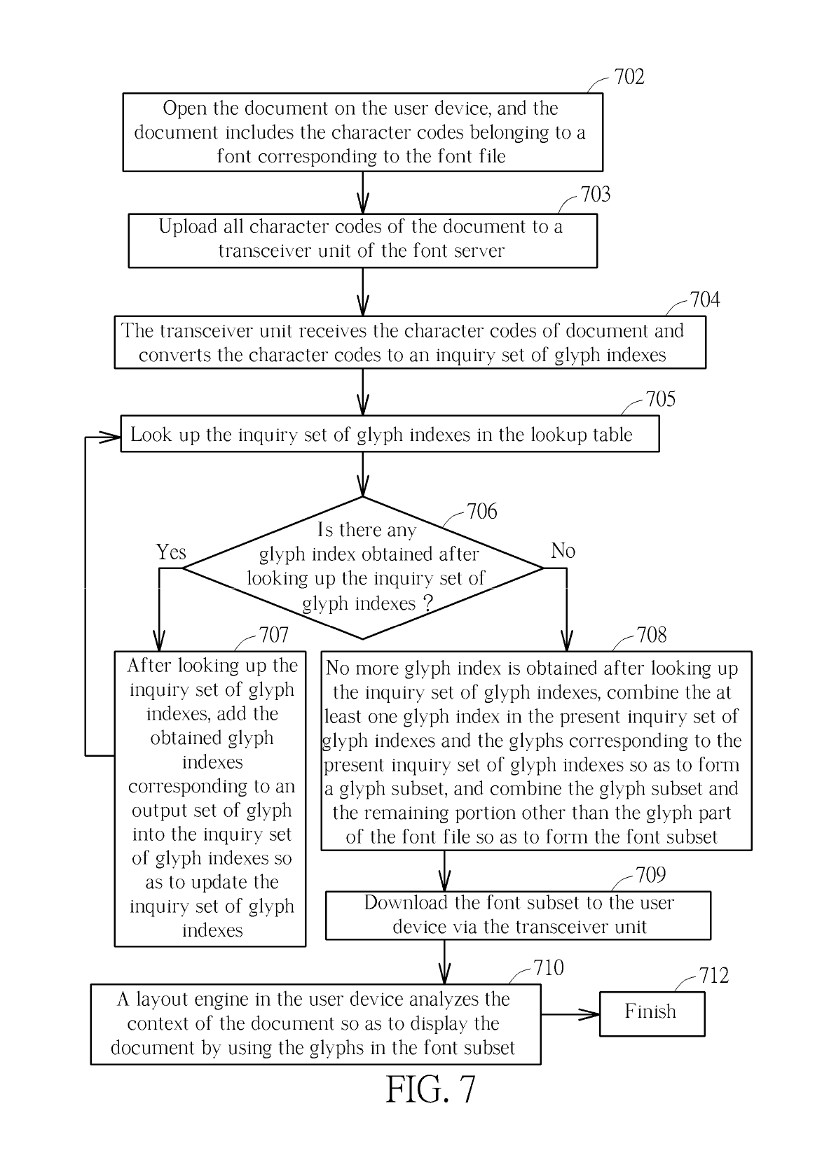

Please refer to FIG. 7 along with FIG. 6. FIG. 7 illustrates a flow chart of a font process method according to an embodiment of the present invention. The steps of the method are described as below:

Step 702: Open the document 6001 on the user device 602, and the document 6001 includes the character codes of document 6002 belonging to a font corresponding to the font file 620;

Step 703: Upload all of the one or more character codes of document 6002 (which may be Unicode codes or ASCII codes) of the document 6001 to a transceiver unit 680 of the font server 601 via a wired or a wireless path;

Step 704: The transceiver unit 680 of the font server 601 receives the character codes of document 6002 and converts the character codes of document 6002 to an inquiry set of glyph indexes 6003;

Step 705: Look up the inquiry set of glyph indexes 6003 in the lookup table 605;

Step 706: Is there any glyph index 1021 obtained after looking up the inquiry set of glyph indexes 6003? If yes, go to Step 707; if no, go to Step 708;

Step 707: After looking up the inquiry set of glyph indexes 6003, add the obtained glyph indexes 1021 corresponding to an output set of glyph into the inquiry set of glyph indexes 6003 so as to update the inquiry set of glyph indexes 6003, and go to Step 705;

Step 708: No more glyph index 1021 is obtained after looking up the inquiry set of glyph indexes 6003, combine the at least one glyph index 1021 in the present inquiry set of glyph indexes 6003 and the glyphs 1022 corresponding to the present inquiry set of glyph indexes so as to forma glyph subset 6211, and combine the glyph subset 6211 and the remaining portion other than the glyph part 6201 of the font file 620 so as to form the font subset 621;

Step 709: Download the font subset 621 to the user device 602 via the transceiver unit 680 and a wired or wireless path;

Step 710: A layout engine in the user device 602 analyzes the context of the document 6001 so as to display the document 6001 by using the glyphs in the font subset 621; go to Step 712;

Step 712: Finish.

The abovementioned character codes of document 6002 are the character codes of the characters in the document 6001. The codes of document 6002 belong to the font corresponding to the font file 620, and can be Unicode codes or ASCII codes. When the document 6001 includes characters belonging to more than one font, for example, Hindi characters belonging to “Prabhki” Font and “Krishna Italic” Font, the character codes of the characters belonging to two (or more) fonts can be processed in parallel by following the above described flow according to an embodiment of the present invention.

After the “inquiry set of glyph indexes 6003” is used as a set of input data to the lookup table 605, if an “output set of glyphs” is obtained, the output set of glyphs is added into the inquiry set of glyph index 6003 to update the inquiry set of glyph index 6003 in the step 707, and the step 705 is performed again so as to look up the updated inquiry set of glyph indexes 6003 in the lookup table 605. If (it is determined in the step 706 that) the updated inquiry set of glyph indexes 6003 still meets some conditions in the lookup table 605, a “re-output set of glyphs” is obtained after the lookup, and the glyph indexes of the re-output set of glyphs are added into the inquiry set of glyph indexes 6003 to update the inquiry set of glyph indexes 6003 again for being put into the lookup table 605 to perform a next round of lookup. A “loop-lookup” process is performed in this way till the updated inquiry set of glyph indexes 6003 do not meet the conditions in the lookup table 605, and no more glyph is obtained after the lookup.

In the obtained glyph subset 6211 in the abovementioned step 708, the number of glyphs must be less than or equal to the number of glyphs in the glyph part 6201 of the font file 620. In the glyph subset 6211, as shown in FIG. 6, all the glyph indexes 1021 are kept, but some of the glyphs 1022 are not stored. Furthermore, it is also allowed to assign new glyph indexes 1021 to the chosen glyphs 1022 stored in the glyph subset 6211. For example, when 1000 glyphs are stored in a glyph part of a font file originally, the corresponding glyph indexes are 0000 to 0999 separately, after the abovementioned steps, the obtained glyph subset includes three glyphs corresponding to the glyph indexes 0025, 0028 and 0555, one of the following arrangements can be adopted in the glyph subset:
(a) Keep all storage positions corresponding to the glyph indexes 0000 to 0999, but only the storage positions corresponding to glyph indexes 0025, 0028 and 0555 stores glyphs; or
(b) Assign new glyph indexes for the glyphs in the glyph subset so that the glyphs originally corresponding to the glyph indexes 0025, 0028 and 0555 are now corresponding to new glyph indexes such as 0000, 0001 and 0002.

In summary, comparing with prior art, the font process method and the font process system disclosed by the present invention reduce download time of downloading a font subset from a font server to a user device, avoid a real-time dynamic analysis on the context-relationship and dependence between characters in a document so as to reduce the analysis time and loading of a processor, and also prevent incorrect displaying of the document caused by the inconsistence of versions or algorithms between the layout engines of the font server and the user device. For widespread users reading documents composed in complex languages such as Hindi, Thai, Bengali and/or Tamil, the font process method and system disclosed by the present invention can greatly enhance the correctness and convenience about reading documents on portable devices or computers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A font process method, comprising:
storing a font file in a font server, the font file having a plurality of glyphs of a font;
analyzing a feature table of the font file so as to collate a code corresponding to each character of the font file, and at least a glyph index of glyphs corresponding to an original form, variation forms, and/or ligatures of the character to form a lookup table;
sending codes of all characters in a document from a user device to the font server;
looking up the codes of all the characters in the document by the font server according to the lookup table so as to capture an inquiry set of glyphs corresponding to the codes of all the characters of the font in the document and an output set of glyphs corresponding to combinations of the codes of all the characters of the font in the document from the font file to form a glyph subset; and
sending the glyph subset from the font server to the user device.

2. The method of claim 1, wherein sending codes of all the characters in the document from the user device to the font server is performed after the lookup table has been formed.

3. The method of claim 1, wherein the lookup table includes at least a corresponding relationship, the corresponding relationship corresponds a set of input data to a set of output data, the set of input data includes at least a glyph and/or at least a code, and the set of output data includes at least a glyph.

4. The method of claim 1, further comprising:
performing a loop-lookup according to the lookup table so as to update the glyph subset, wherein the loop-lookup is performed by looking up the inquiry set of glyphs and the output set of glyphs captured from the font file according to the lookup table so as to form a re-output set of glyphs for updating the glyph subset, and the font subset is formed by combining the updated glyph subset and a remaining portion other than the plurality of glyphs in the font file.

5. A font process method, comprising:
storing a font file in a font server, the font file having a plurality of glyphs of a font;
analyzing a feature table of the font file so as to collate a code corresponding to each character of the font file, and at least a glyph index of glyphs corresponding to an original form, variation forms, and/or ligatures of the character to form a lookup table;
sending codes of all characters in a document from a user device to the font server;
looking up the codes of all the characters in the document by the font server according to the lookup table so as to capture an inquiry set of glyphs corresponding to the codes of all the characters of the font in the document and an output set of glyphs corresponding to combinations of the codes of all the characters of the font in the document from the font file to form a glyph subset;
combining the glyph subset and a remaining portion other than the plurality of glyphs in the font file to form a font subset; and
sending the font subset from the font server to the user device.

6. The method of claim 5, wherein sending codes of all the characters in the document from the user device to the font server is performed after the lookup table has been formed.

7. The method of claim 5, wherein the lookup table includes at least a corresponding relationship, the corresponding relationship corresponds a set of input data to a set of output data, the set of input data includes at least a glyph and/or at least a code, and the set of output data includes at least a glyph.

8. The method of claim 5, further comprising:
performing a loop-lookup according to the lookup table so as to update the glyph subset, wherein the loop-lookup is performed by looking up the inquiry set of glyphs and the output set of glyphs captured from the font file according to the lookup table so as to form a re-output set of glyphs for updating the glyph subset, and the font subset is formed by combining the updated glyph subset and a remaining portion other than the plurality of glyphs in the font file.

9. A font process system, comprising:
a user device, having a document; and
a font server, having:
a font file storing a plurality of glyphs of a font, the font file having a feature table; and
a lookup table formed by analyzing the feature table so as to collate a code corresponding to each character of the font file, and at least a glyph index of glyphs corresponding to an original form, variation forms, and/or ligatures of the character;
wherein the user device sends codes of all characters in the document from the user device to the font server;
the font server looks up the codes of all the characters in the document according to the lookup table so as to capture an inquiry set of glyphs corresponding to the codes of all the characters of the font in the document and an output set of glyphs corresponding to combinations of the codes of all the characters of the font in the document from the font file to form a glyph subset;
the font server combines the glyph subset and a remaining portion other than the plurality of glyphs in the font file to form a font subset; and
the font server sends the font subset to the user device.

10. The system of claim 9, wherein the lookup table is formed by analyzing a set of linguistic rules.

11. The system of claim 9, wherein the lookup table is partially formed with manual review.

12. The system of claim 9, wherein the user device is a mobile phone, a laptop computer, an industry computer, a television, a wearable device, a smart home appliance, a car electronic device or a display device coupled to an internet.

13. The system of claim 9, wherein:
the font server performs a loop-lookup according to the lookup table so as to update the glyph subset by looking up the inquiry set of glyphs and the output set of glyphs captured from the font file according to the lookup table so as to form a re-output set of glyphs for updating the glyph subset; and
the font server combines the updated glyph subset and a remaining portion other than the plurality of glyphs in the font file to form the font subset.
